(19) United States
(12) Patent Application Publication
(10) Pub. No.: US 2008/0045420 A1
(43) Pub. Date: Feb. 21, 2008

(54) Zwitterionic Polymers Comprising Betaine-Type Units And Use Of Zwitterionic Polymers In Drilling Fluids

(76) Inventors: Katerina Karagianni, Paris (FR); Marie-Pierre Labeau, Paris (FR); Radmila Kubat, Paris (FR)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(21) Appl. No.: 10/582,722

(22) PCT Filed: Dec. 15, 2004
(86) PCT No.: PCT/FR04/03239

§ 371 Date: Apr. 2, 2007

(30) Foreign Application Priority Data
Dec. 15, 2003 (FR) 0314675

(51) Int. Cl. C08F 220/20; C08F 220/26; C08F 220/34

(52) U.S. Cl. 507/121; 528/332

(57) ABSTRACT

The invention relates to novel polymers comprising betaine-type units and to the use of zwitterionic polymers in drilling fluids, for example, as a clay swelling inhibitor and/or as an accretion-inhibiting agent and/or as a fluid-rheology-controlling agent and/or a filtrate-reducing agent and/or a lubricant.

The subject matter of the present invention is novel polymers comprising betaine-type units and the use of zwitterionic polymers in drilling fluids, in particular as agent for inhibiting the swelling of clays.

During operations for the drilling of wells, in particular of wells intended to recover underground oil and/or gas fields, use is made of drilling fluids intended to lubricate, clean and cool the drilling tools and the drilling head and/or to discharge the material given off during drilling operations (cleared rocks). Drilling fluids are also used to clean the well. They also provide the pressure necessary to support the wall of the well before consolidation. The fluids are usually known as “drilling muds”. After drilling, the walls of the well are generally consolidated with a cement material.

During drilling, the walls of the rock, in particular of water-sensitive argillaceous rocks, have a tendency to swell. Operational problems are related to these clays. The swelling can interfere with the flow of the fluid or the passage of the drilling tool. Furthermore, the swelling can lead to disintegration of the wall. This disintegration can cause irregularities in the well and can thus create points of mechanical weakness. Furthermore, the disintegrated argillaceous material is released into the fluid and can present problems of control of the viscosity of the fluid: argillaceous materials, in the presence or absence of a high concentration of salts (brine), have a tendency to greatly increase the viscosity. This increase may be harmful: if it becomes too high, the drilling tools are damaged. The well can even be rendered unusable.

Furthermore, cleared argillaceous rocks may have a tendency to aggregate together in the drilling fluid. This phenomenon is referred to as an accretion phenomenon. The accretion may interfere with the circulation of the fluids and can mechanically block the drilling head (bit-balling phenomenon).

To solve these problems, it is known to add, to drilling fluids, polymers intended to consolidate the walls (well bore consolidation). Thus, use is commonly made, inter alia, of partially hydrolyzed polyacrylamides (PHPA). It is believed that these polymers form a polymeric film at the surface of the walls, more or less encapsulate the cleared rocks and thus inhibit the hydration and/or the disintegration of the clays. However, the performance of these polymers is limited as they have a tendency to render the fluids excessively viscous at high concentration. Furthermore, the performance of these polymers is limited under high temperature-high pressure (HTHP) drilling conditions.

Moreover, it is known that other polymers can be added to drilling fluids, for example in order to adjust their rheological properties, in particular in the presence of salts. Some studies have thus been carried out on copolymers comprising units of betaine type and often acrylamide units.

The agents known to inhibit the swelling of the clays can even the promote the accretion.

Thus, copolymers based on acrylamide and on sulfobetaines or on phosphobetaines are disclosed in the document WO 00/01746 (Institut Français du Pétrole). It is indicated in this document that these copolymers are effective as viscosifying agent and as agent for modifying the surfaces of suspended particles.

Increasingly restrictive legislation is targeted at limiting the use of polymers comprising acrylamide units. Such polymers will perhaps no longer be able to be used in some countries, sooner or later. Replacement solutions are necessary.

The document U.S. Pat. No. 5,026,490 discloses other copolymers comprising sulfobetaine units and their use as deflocculating agent for drilling muds. The document U.S. Pat. No. 6,346,588 discloses other copolymers comprising sulfo-betaine units, the formulation of which in a drilling fluid is facilitated. The document U.S. Pat. No. 4,607,076 discloses other copolymers comprising sulfobetaine units and their use as viscosifying agent in the presence of brine.

The present invention provides a novel polymer comprising betaine-type units. Another object of the present invention is to provide a polymer which can be used as clay-swelling inhibitor and/or as filtrate-reducing agent and/or as lubricating agent and/or as 2-in-1 agent for lubrication and inhibiting the swelling of clays, for example in drilling fluids, in particular in aqueous or nonaqueous fluids, especially in silicate-based fluids. In addition, the invention provides replacement solutions for the polymers comprising acrylamide units.

Thus, the invention provides a zwitterionic polymer comprising units comprising a betaine group, characterized in that it comprises:
at least 35 mol % of units comprising a betaine group, the betaine group comprising a cationic group and an anionic group, and
additional units chosen from:
   alkoxylated units of following formula:

—CH₂—CHR⁶[—X²—(CH₂—CH₂—O)ₙ—R⁷]—

in which:
R⁶ is a hydrogen atom or a methyl group,
X²is a group of formula —CO—O—, —CO—NH— or —C₆H₄—CH₂—,
n is an integer or mean number of greater than or equal to 1,
R⁷ is a hydrogen atom, an alkyl group or a tristyrylphenyl group, and/or
hydroxylated units of following formula:

—CH₂—CHR⁶[—X²—R⁸]—

in which:
R⁶ is a hydrogen atom or a methyl group,
X² is a group of formula —CO—O—, —CO—NH— or —C₆H₄—CH₂—,
R⁸ is a hydrocarbon group of at least two carbon atoms comprising at least two —OH groups, preferably on two consecutive carbon atoms.

The invention also relates to a drilling fluid and more particularly to a drilling fluid for oil and/or gas wells comprising the polymer. The fluid can in particular be a silicate-based fluid.

The invention also relates to the use of a zwitterionic polymer comprising at least 35 mol % of units comprising a betaine group, the betaine group comprising a cationic group and an anionic group, in a drilling fluid as clay-swelling inhibitor and/or as accretion-inhibiting agent and/or as fluid-rheology-agent controlling bore consolidation agent and/or as filtrate-reducing agent and/or as lubricating agent, for example as well agent or for inhibiting the accretion of the cleared drilled rocks (inhibition of bit-balling phenomena) or lubricating well bore, or as 2-in-1 agent, for lubrication and consolidation or inhibition of accretion, or for inhibition of the swelling of the clays (or consolidation well bore) and inhibition of accretion. The polymer can also be used as filtrate-reducing agent.

### Polymer

The polymer according to the invention comprises at least two types of units. It is thus a copolymer. The polymer is preferably a random copolymer. According to a preferred embodiment, the polymer does not comprise units other than those mentioned. The polymer preferably exhibits solely the units comprising a betaine group and the alkoxylated units or solely the units comprising a betaine group and the hydroxylated units. The polymer is thus preferably a binary copolymer, in contrast to a terpolymer.

Unless otherwise indicated, when the term “molar mass” will be used, the reference will be to the absolute weight-average molar mass, expressed in g/mol. The latter can be determined by aqueous gel permeation chromatography (GPC), by light scattering (DDL or also MALLS), with an aqueous eluent or an organic eluent (for example, dimethylacetamide, dimethylformamide, and the like), depending on the composition of the polymer.

In the present patent application, the term “unit deriving from a monomer” denotes a unit which can be obtained directly from said monomer by polymerization. Thus, for example, a unit deriving from an acrylic or methacrylic acid ester does not include a unit of formula —CH₂—CH(COOH)—, —CH₂—C(CH₃) (COOH)— or —CH₂—CH(OH)—, respectively, for example obtained by polymerizing an acrylic acid ester, a methacrylic acid ester or vinyl acetate respectively, and then hydrolyzing. A unit deriving from acrylic or methacrylic acid includes, for example, a unit obtained by polymerizing a monomer (for example, an acrylic or methacrylic acid ester) and by then reacting the polymer obtained (for example by hydrolysis), so as to obtain units of formula —CH₂—CH(COOH)— or —CH₂—C(CH₃) (COOH)—. A unit deriving from a vinyl alcohol includes, for example, a unit obtained by polymerizing a monomer (for example a vinyl ester) and by then reacting the polymer obtained (for example by hydrolysis), so as to obtain units of formula —CH₂—CH(OH)—.

As 1st group of units, the polymer comprises units comprising a betaine group which comprises a cationic group and an anionic group. Within these units, the number of positive charges is equal to the number of negative charges. The units are electrically neutral. These units are zwitterionic units and the polymer is thus zwitterionic. The polymer is thus generally electrically neutral, insofar as the other units are neutral. This is the case for the polyalkoxylated units or the hydroxylated units present in the polymer. The proportion in moles of units comprising a betaine group is at least 35%.

The betaine group exhibits a permanent anionic charge and a permanent cationic charge within at least one pH range. This permanent anionic charge can be contributed by one or more carbonate, sulfonate, phosphate, phosphonate, phosphinate or ethenolate anions, and the like. The cationic charge can be contributed by one or more onium or inium cations of the nitrogen family (ammonium, pyridinium, imidazolinium cations), phosphorus family (phosphonium, and the like) or sulfur family (sulfonium, and the like).

Preferably, the betaine groups are pendent groups of the polymer (they are positioned in comb-like fashion along the macromolecular chain of the polymer).

The betaine groups can be represented, in the case of the cations of the nitrogen family, by the following formulae (I) to (V), which exhibit a cationic charge at the center of the functional group and an anionic charge at the end of the functional group, and formula (VI), which exhibits an anionic charge at the center of the functional group and a cationic charge at the end of the functional group:

—N⁽⁺⁾(R¹)(R²)—R-A—O⁽⁻⁾ (I)

—(R³)C═N⁽⁺⁾(R⁴)—R-A—O⁽⁻⁾ (II)

—(R³)(R)C—N⁽⁺⁾(R⁴)(R⁶)—R-A—O⁽⁻⁾ (III)

—N⁽⁺⁾(═R⁶)—R-A—O⁽⁻⁾ (IV)

—N⁽⁺⁾(R¹)(R²)—R—W⁽⁻⁾ (V)

—R-A′(—O⁽⁻⁾)—R—N⁽⁺⁾(R¹)(R²)(R⁷) (VI)

in which formulae (I) to (IV):
the symbols R¹, R² and R⁵, which are identical or different, represent an alkyl radical comprising from 1 to 7 carbon atoms, preferably from 1 to 2 carbon atoms,
the symbols R³ and R⁴ represent hydrocarbon radicals which form, with the nitrogen atom, a nitrogenous heterocycle optionally comprising one or more other heteroatoms, in particular nitrogen,
the symbol R⁶ represents a hydrocarbon radical which forms, with the nitrogen atom, a saturated or unsaturated nitrogenous heterocycle optionally comprising one or more other heteroatoms, in particular nitrogen,
the symbol R represents a linear or branched alkylene radical comprising from 1 to 15 carbon atoms, preferably from 2 to 4 carbon atoms, optionally substituted by one or more hydroxyl groups, or a benzylene radical,
the symbol A represents S(═O) (═O), OP(═O) (═O), OP(═O)(OR′), P═(O)(OR′) or P(═O)(R′), where R′ represents an alkyl radical comprising from 1 to 7 carbon atoms or a phenyl radical,
   in which formula (V):
the symbols R¹, R² and R have the definitions given above,
the symbol W represents an ethenolate functional group of formula:

O—C(O⁽⁻⁾═C(C≡N)₂

O—C(O)—C⁽⁻⁾(C≡N)₂

O—C(O)—C(—C≡N) (═C═N⁽⁻⁾)

in which formula (VI):
the symbols R¹ and R² have the definitions given above,
the symbol R⁷, which is identical to or different from R¹ or R², represents an alkyl radical comprising from 1 to 7 carbon atoms, preferably from 1 to 2 carbon atoms,
the symbol A′ represents —O—P(═O)—O—.

In the case of cations of the phosphorus family, mention may be made of the betaine groups of formulae (VII) and (VIII):

—P⁽⁺⁾ (R¹(R²)—R-A—O(⁻) (VII)

—R-A′-(—O⁽⁻⁾)—R—P⁽⁺⁾(R¹) (R²) (R⁷) (VIII)

in which formula (VII) the symbols R¹, R², R and A have the definitions given above,
in which formula (VIII):
   symbols R¹, R², R⁷ and R have the definitions given above,
   the symbol A′ represents —O—P(═O)—O—.

In the case of cations of the sulfur family, mention may be made of the betaine groups of formulae (IX) and (X):

—S⁽⁺⁾(R¹)—R-A—O⁽⁻) (IX)

—R-A′(—O⁽⁻⁾)—R—S⁽⁺⁾(R¹) (R²) (X)

in which formula (IX) the symbols R¹, R and A have the definitions given above,
in which formula (X):
   the symbols R¹, R² and R have the definitions given above,
   the symbol A′ represents —O—P(═O)—O—.

The units comprising a betaine group and optionally the alkoxylated and/or hydroxylated units preferably form a polyalkylene hydrocarbon chain (also referred to as backbone) optionally interrupted by one or more nitrogen or sulfur atoms.

The betaine groups can be connected to the carbon atoms of a hydrocarbon chain of the polymer via in particular a divalent or polyvalent hydrocarbon unit (for example, alkylene or arylene) optionally interrupted by one or more heteroatoms, in particular oxygen, an ester unit, an amide unit, or else by a valency bond.

In the polymer, the body of units comprising a betaine group can be composed of identical or different units.

The polymer can in particular be obtained by radical polymerization in aqueous solution of monomers comprising a monomer of formula

CH₂═CHR⁶[—X—(CH₂—CH₂—O)ₙ—R⁷] or a monomer of formula CH₂═CHR⁶[—X²—R⁸]

and of monomers comprising an ethylenically unsaturated betaine group, in particular of ethylenically unsaturated monomers carrying at least one betaine group of above formulae (I) to (X).

Said monomers can exhibit, by way of example:
one or more mono- or polyethylenically unsaturated hydrocarbon radicals (in particular vinyl, allyl, styryl, and the like),
one or more mono- or polyethylenically unsaturated ester radicals (in particular acrylate, methacrylate, maleate, and the like),
one or more mono- or polyethylenically unsaturated amide radicals (in particular acrylamido, methacrylamido, and the like).

The units comprising a betaine group can derive from at least one betaine monomer selected from the group composed of the following monomers:
alkyl sulfonates or phosphonates of dialkylammonium alkyl acrylates or methacrylates, acrylamido or methacrylamido, such as:
   sulfopropyldimethylammonioethyl methacrylate, sold by Raschig under the name SPE:

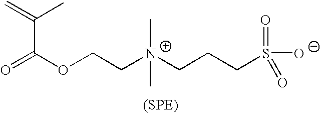

sulfoethyldimethylammonioethyl methacrylate and sulfobutyldimethylammonioethyl methacrylate:

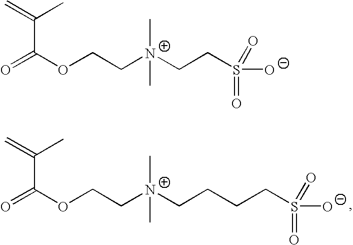

the synthesis of which is described in the paper “Sulfobetaine zwitterionomers based on n-butyl acrylate and 2-ethoxyethyl acrylate: monomer synthesis and copolymerization behavior”, Journal of Polymer Science, 40, 511-523 (2002),
sulfohydroxypropyldimethylammonioethyl methacrylate:

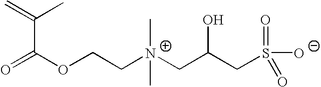

sulfopropyldimethylammoniopropylacrylamide:

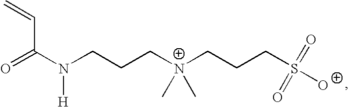

the synthesis of which is described in the paper “Synthesis and solubility of the poly(sulfobetaine)s and the corresponding cationic polymers: 1. Synthesis and characterization of sulfobetaines and the corresponding cationic monomers by nuclear magnetic resonance spectra”, Wen-Fu Lee and Chan-Chang Tsai, Polymer, 35 (10), 2210-2217 (1994),
sulfopropyldimethylammoniopropylmethacrylamide, sold by Raschig under the name SPP:

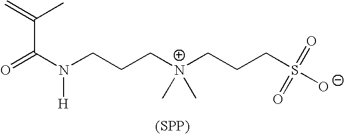

sulfohydroxypropyldimethylammoniopropyl-methacrylamide:

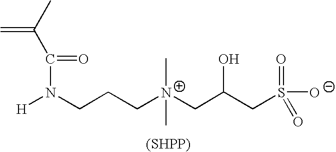

sulfopropyldiethylammonioethyl methacrylate:

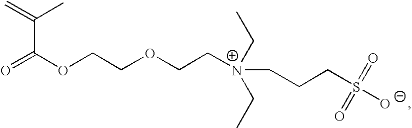

the synthesis of which is described in the paper “Poly(sulphopropylbetaines): 1. Synthesis and characterization”, V. M. Monroy Soto and J. C. Galin, Polymer, 1984, Vol. 25, 121-128,
sulfohydroxypropyldiethylammonioethyl methacrylate:

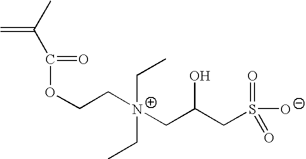

heterocyclic betaine monomers, such as:
   sulfobetaines derived from piperazine:

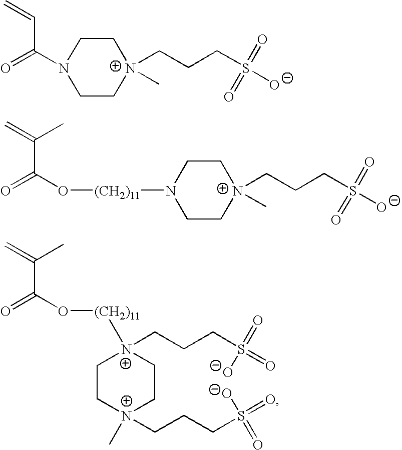

the synthesis of which is described in the paper “Hydrophobically Modified Zwitterionic Polymers: Synthesis, Bulk Properties, and Miscibility with Inorganic Salts”, P. Koberle and A. Laschewsky, Macromolecules, 27, 2165-2173 (1994),
sulfobetaines derived from 2-vinylpyridine and 4-vinylpyridine, such as
   2-vinyl-1-(3-sulfopropyl)pyridinium betaine (2SPV), sold by Raschig under the name SPV:

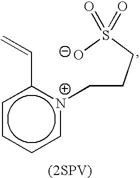

4-vinyl-1-(3-sulfopropyl)pyridinium betaine (4SPV), the synthesis of which is disclosed in the paper “Evidence of ionic aggregates in some ampholytic polymers by transmission electron microscopy”, V. M. Casta n̅o and A. E. González, J. Cardoso, O. Manero and V. M. Monroy, J. Mater. Res., 5 (3), 654-657 (1990):

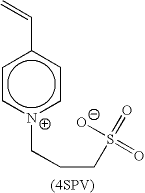

1-vinyl-3-(3-sulfopropyl)imidazolium betaine:

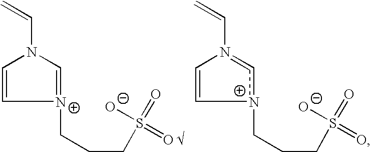

the synthesis of which is described in the paper “Aqueous solution properties of a poly(vinyl imidazolium sulphobetaine)”, J. C. Salamone, W. Volkson, A. P. Oison, S. C. Israel, Polymer, 19, 1157-1162 (1978),
alkyl sulfonates or phosphonates of dialkylammonium alkyl allylics, such as sulfopropyl-methyldiallylammonium betaine:

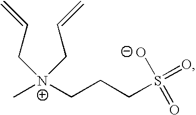

the synthesis of which is described in the paper “New poly(carbobetaine)s made from zwitterionic diallylammonium monomers”, Favresse, Philippe; Laschewsky, Andre, Macromolecular Chemistry and Physics, 200(4), 887-895 (1999),
alkyl sulfonates or phosphonates of dialkylammonium alkyl styrenes, such as:

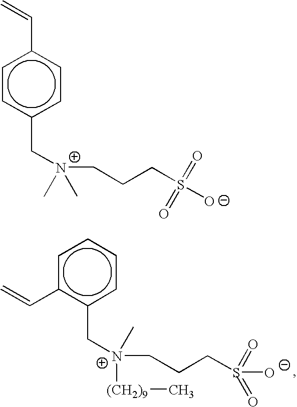

the synthesis of which is described in the paper “Hydrophobically Modified Zwitterionic Polymers: Synthesis, Bulk Properties, and Miscibility with Inorganic Salts”, P. Koberle and A. Laschewsky, Macromolecules, 27, 2165-2173 (1994),
betaines resulting from ethylenically unsaturated anhydrides and dienes, such as:

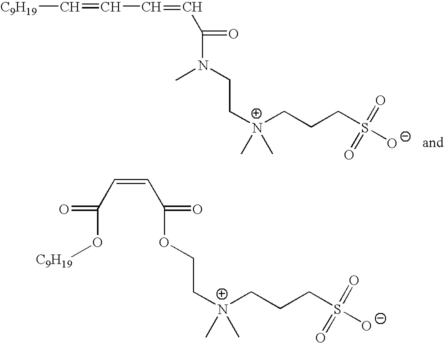

the synthesis of which is described in the paper “Hydrophobically Modified Zwitterionic Polymers: Synthesis, Bulk Properties, and Miscibility with Inorganic Salts”, P. Koberle and A. Laschewsky, Macromolecules, 27, 2165-2173 (1994),
phosphobetaines, such as:

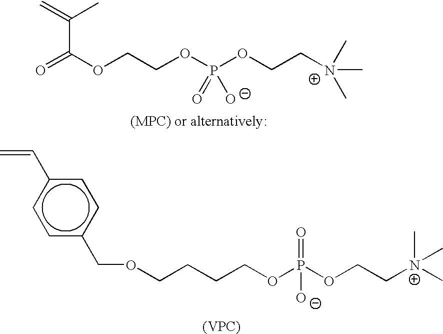

### The synthesis of MPC and of VPC is disclosed in EP 810 239 B1 (Biocompatibles, Alister et al.).

betaines resulting from cyclic acetals, such as ((dicyanoethanolate)ethoxy)dimethylammoniumpropyl-methacrylamide:

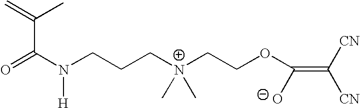

the synthesis of which is described by M- L. Pujol-Fortin et al. in the paper “Poly(ammonium alkoxy-dicyanatoethenolates) as new hydrophobic and highly dipolar poly(zwitterions). 1. Synthesis”, Macromolecules, 24, 4523-4530 (1991).

The polymer according to the invention can also be obtained in a known way by chemical modification of a polymer referred to as a precursor polymer. Thus, sulfobetaine units can be obtained by chemical modification, using a sultone (propane sultone, butane sultone), a haloalkylsulfonate or any other sulfonated electrophilic compound, of a polymer comprising pendent amine functional groups.

A few synthetic examples are given below:

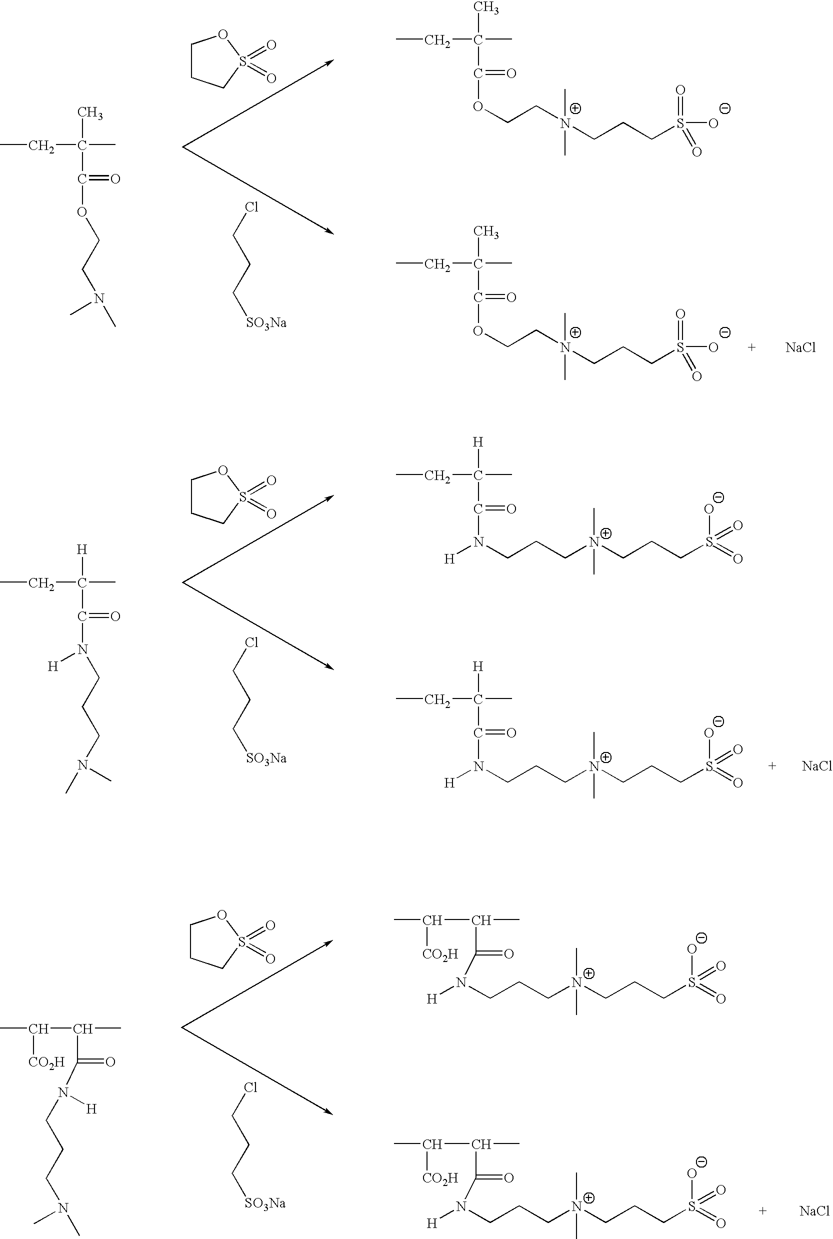

The main routes of access by chemical modification of a precursor polymer by sultones and haloalkylsulfonates are described in particular in the following documents:
“Synthesis and aqueous solution behaviour of copolymers containing sulfobetaine moieties in side chains”, I. V. Berlinova, I. V. Dimitrov, R. G. Kalinova, N. G. Vladimirov, Polymer, 41, 831-837 (2000)
“Poly(sulfobetaine)s and corresponding cationic polymers: 3. Synthesis and dilute aqueous solution properties of poly(sulfobetaine)s derived from styrene-maleic anhydride”, Wen-Fu Lee and Chun-Hsiung Lee, Polymer, 38 (4), 971-979 (1997)
“Poly(sulfobetaine)s and corresponding cationic polymers. VIII. Synthesis and aqueous solution properties of a cationic poly(methyl iodide quaternized styrene-N,N-dimethylaminopropyl maleamidic acid) copolymer”, Lee, Wen-Fu and Chen, Yan-Ming, Journal of Applied Polymer Science, 80, 1619-1626 (2001)
“Synthesis of polybetaines with narrow molecular mass distribution and controlled architecture”, Andrew B. Lowe, Norman C. Billingham and Steven P. Armes, Chem. Commun., 1555-1556 (1996)
“Synthesis and Properties of Low-Polydispersity Poly(sulfopropylbetaine)s and Their Block Copolymers”, Andrew B. Lowe, Norman C. Billingham and Steven P. Armes, Macromolecules, 32, 2141-2146 (1999)
Japanese patent application published on Dec. 21, 1999 under the number 11-349826.

The preparation of polyphosphonato- and phosphinatobetaines by chemical modification is reported in “New polymeric phosphonato-, phosphinato- and carboxybetaines”, T. Hamaide, Macromolecular Chemistry, 187, 1097-1107 (1986).

According to a preferred embodiment, the units comprising a betaine group exhibit one of the following formulae:

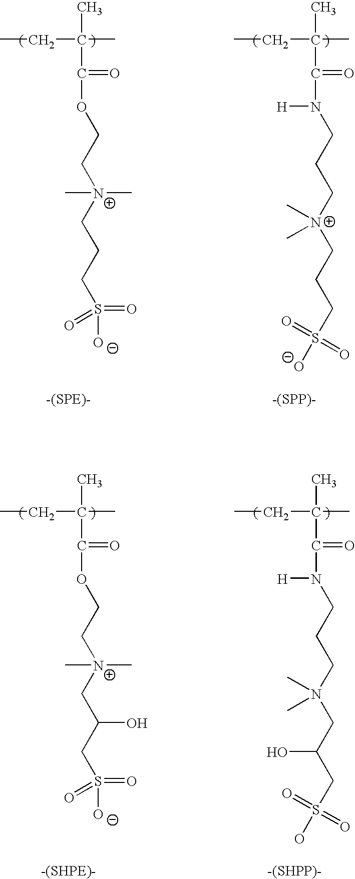

The polymer according to the invention can also comprise alkoxylated units of following formula:

—CH₂—CHR⁶[—X²—(CH₂—CH₂—O)ₙ—R⁷]—

in which:
R⁶ is a hydrogen atom or a methyl group,
X² is a group of formula —CO—O—, —CO—NH— or —C₆H₄—CH₂—,
n is an integer or mean number of greater than or equal to 1,
R⁷ is a hydrogen atom, an alkyl group or a tristyrylphenyl group.

Preferably, the alkoxylated units are units deriving from a monomer of following formula:

CH₂═CHCH₃COO—(CH₂—CH₂—O)ₙ—R⁷

in which:
n is an integer or mean number of greater than or equal to 1,
R⁷ is an alkyl group comprising 1 to 30 carbon atoms or a tristyrylphenyl group.

According to a first preferred form, the monomer is such that:
n is greater than or equal to 10, preferably greater than or equal to 15, and
R⁷ is a methyl group.

Mention is made, as example of alkoxylated monomer for this first embodiment, of α-monomethacrylate ω)-methoxy PEG 1000, for example Bisomer S10W sold by Laporte, in which n is equal to approximately 22. According to a second preferred form, the monomer is such that:
n is greater than or equal to 10, and
R⁷ is an alkyl group comprising from 12 to 30 carbon atoms, preferably from 18 to 25.

Mention is made, as example of alkoxylated monomer for this second embodiment, of Sipomer BEM sold by Rhodia, in which n is equal to approximately 25 and the number of carbon atoms is 22.

According to a third preferred form, the monomer is such that:
n is greater than or equal to 10, and
R⁷ is a tristyrylphenyl group.

Mention is made, as example of alkoxylated monomer for this third embodiment, of Sipomer SEM 25 sold by Rhodia, in which
n is equal to approximately 25.

According to a fourth preferred form, the monomer is such that:
n is greater than or equal to 10, and
R⁷ is a hydrogen atom.

The polymer according to the invention can also comprise hydroxylated units of following formula:

—CH₂—CHR⁶[—X²—R⁸]—

in which:
—R⁶ is a hydrogen atom or a methyl group,
X² is a group of formula —CO—O—, —CO—NH— or —C₆H₄—CH₂—,
R⁸ is a hydrocarbon group of at least two carbon atoms comprising at least two —OH groups, preferably on two consecutive carbon atoms.

They can, for example, be units of formula:

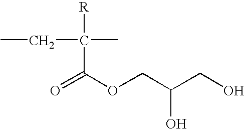

in which R and the group R⁶, hydrogen or methyl group.

Mention is made of the following units:

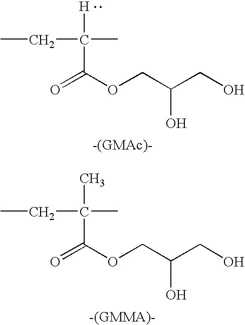

### Mention may be made, as example of monomers resulting in such units after (co)polymerization, of glycerol monoacrylate (GMAc) or glycerol monomethacrylate (GMMA, sold by Rohm):

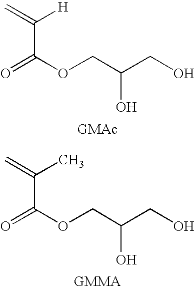

The hydroxylated units can also be obtained by chemical modification of a precursor polymer comprising, for example, epoxy units:

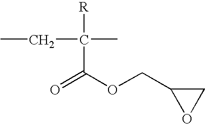

### Mention may be made, as example of monomers resulting in such units after (co)polymerization, of glycidyl acrylate (GA) or glycidyl methacrylate (GMA):

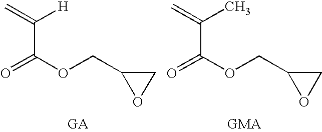

The weight-average molar mass is preferably between 5000 g/mol and 400 000 g/mol (relative value, calibrated in aqueous GPC with poly(ethylene oxide) standards). The absolute weight-average molar mass can preferably be between 10 000 and 4 000 000 g/mol.

According to an advantageous embodiment, the polymer comprises:
from 65 to 99 mol % of units comprising a betaine group,
from 55 to 1 mol % of alkoxylated units, preferably:
from 70 to 90 mol %, preferably from 80 to 90 mol %, of units comprising a betaine group,
from 10 to 30 mol %, preferably from 10 to 20 mol %, of alkoxylated units.

According to another advantageous embodiment, the polymer comprises:
from 80 to 100 (excluded) mol % of units comprising a betaine group,
from 20 to 0 (excluded) mol % of hydroxylated units.

### Drilling Fluids

The invention relates, according to one aspect, to a drilling fluid comprising the polymer. It can be an aqueous or nonaqueous fluid. It can be a silicate-based aqueous fluid (or “silicate-based mud”) or silicate-free aqueous fluid. It can be a phosphate-based or phosphate-free aqueous fluid. Phosphate-free and silicate-free fluids may be concerned.

The polymer content of the drilling fluid is advantageously between 0.1% and 10%, preferably between 0.1% and 5% and more preferably still between 1% and 3%.

The polymers comprising hydroxylated units are particularly advantageous for silicate-based aqueous fluids or uses in these fluids.

The polymers comprising alkoxylated units are particularly advantageous for silicate-free aqueous fluids.

A brief description of drilling operations is given below.

The drilling operations consist in excavating a hole using a bit, made in particular of tungsten carbide, attached to hollow pipes screwed end to end. Generally, mud, or drilling fluid, comprising additives in a liquid vehicle is injected into the string of pipes. This mud subsequently comes back up via the borehole, outside the pipes, and carries along rock components detached during the drilling operation. At the same time, the rock-laden mud establishes a counterpressure which consolidates the hole. The mud is subsequently extracted from the drilling hole in order to be freed from the rocks which are present therein before being reinjected into the hollow drilling pipes.

Under such operating conditions, additives added to the mud confer a specific rheological behavior thereon. This is because, when it is subjected to very high shear stresses and high temperatures, as is the case in the bit, the fluid has to have a sufficiently low viscosity to facilitate the discharge thereof towards the outside of the hollow pipes. In contrast, the same fluid, laden with rocks, has to exhibit a high viscosity in order to keep in suspension the cuttings entrained during the drilling.

Drilling fluids (mud) are known to a person skilled in the art. The exact composition of the fluid can depend on the destination of the fluid. It can depend in particular on the temperatures and pressures to which the fluid will be subjected, on the nature of the rocks through which the well passes and on the nature of the drilling equipment.

Drilling fluids generally comprise a liquid vehicle and additives dissolved or dispersed in the liquid vehicle. Well bore consolidation agents and filtrate-reducing agents are such additives.

The liquid vehicle can be water (the drilling fluid being a water-based composition comprising additives dissolved or dispersed in water). In this case, the term “water mud” is often used. It should be mentioned that the water is often seawater. According to a specific form, the liquid vehicle is a silicate-based vehicle (“silicate-based mud”). Silicate-based muds are a category of water muds comprising silicates. They are known to a person skilled in the art. These muds are highly effective in terms of protecting water-sensitive clays, they are not very expensive and are regarded as having a low impact on the environment. They are capable of blocking fissures in clays with a size from a few nanometers up to tens of micrometers. Nevertheless, they have disadvantages in terms of the accretion of the cuttings and blocking of the drilling heads (bit-balling). Another disadvantage is the high operational pH (approximately 12), which causes risks in terms of safety of the working conditions and/or of impact on the environment, as well as poor lubrication. Liquid sodium or potassium silicates are solutions of water-soluble glasses with the chemical formula: M₂Oₙ(SiO₂), where M can be Na+ or K+ and n is the molar ratio (the number of SiO₂ molecules per one M₂O molecule). n preferably varies from 1.5 to 3.3 for commercial products. In drilling fluids, the ratio 2.0 is typically used. It is believed that the silicates protect water-sensitive native clays from invasion by water via two mechanisms:
gelling: the fluid in the pores of the clays has a pH close to neutral. When the silicate oligomers are brought to this pH, they polymerize and form three-dimensional networks.
precipitation: the fluid in the pores of the clays comprises Ca²⁺ and Mg²⁺ cations which interact with the silicate oligomers to form insoluble precipitates.

The liquid vehicle can also be a water-in-oil emulsion. In this case, the term “oil mud” is often used. The latter are more expensive than water muds but may be preferred in the case of the drilling of very deep wells (HP/HT (high pressure/high temperature) conditions). The polymer can be used with both types of vehicles. However, water-based vehicles (water mud) are preferred, in particular silicate-based vehicles (silicate-based mud).

The polymer according to the invention can participate in the composition of the drilling fluid by replacing or by complementing a well bore consolidation agent and/or filtrate-reducing agents and/or lubricating agents and/or accretion-inhibiting agents.

Mention should be made, among the additives which can be included in drilling fluids, in addition to well bore consolidation agents and/or filtrate-reducing agents, of:
agents for controlling the rheology: they can be agents which render the fluid viscoelastic, shear-thinning agents or thickening agents. Mention should be made, for example, of polysaccharides, such as guar gum or starch, xanthan gums and derivatives of these compounds.
agents for controlling the ionic strength of the fluid. They are, for example, salts.
emulsifiers, in particular in oil muds, for example the emulsifiers disclosed in patent application WO 01/94495.
dispersants.
scale inhibitors, for example polymers comprising units derived from acrylic acid or from vinylsulfonic acid.
agents for controlling the density of the fluid, for example barium sulfate.
oxygen scavengers and/or other chemical stabilizers.

However, further details with regard to certain compounds which can participate in the composition of drilling fluids are given below.

Drilling fluids can comprise polyphosphates, tannins, lignosulfonates, lignin derivatives, peats and lignites, polyacrylates or polynaphthalenesulfonates, alone or as a mixture.

The amount of thinning agent or dispersant can vary. By way of indication, this amount is between 0 and 1%, with respect to the total weight of the fluid.

The drilling fluid according to the invention can additionally comprise an oxygen scavenger. The object of this type of additive is to scavenge the oxygen present in the drilling muds, which can bring about decomposition of certain additives.

Mention may be made, among the products of this type, for example, of hydroxylamines, hydrazine, sulfites, bisulfites, dithionites or borohydrides.

According to a specific embodiment, hydrazine is used as oxygen scavenger as it does not bring about the formation of insoluble precipitates which promote the appearance of blockages in the well. The hydrazine may be in anhydrous or hydrated form, in the form of salts, such as, for example, the chloride or sulfate, or also in the carbohydrazide form.

Generally, the content of additive of this type varies between 0 and 0.25%.

The drilling fluid according to the invention can furthermore comprise at least one weighting compound and/or at least one inorganic colloid.

The weighting components contribute to maintaining a sufficient hydrostatic pressure in the well and to keeping in suspension the rocks entrained during the drilling operation. Such compounds are conventionally chosen from the abovementioned soluble salts and from salts of low or very low solubility. Mention may be made, among salts of low solubility, without intending to be restricted thereto, of alkaline earth metal sulfates, silicates or carbonates, such as barium sulfate or calcium carbonate.

Use may likewise be made of alkaline earth metal or zinc bromides, such as potassium bromide or zinc bromide. Use may also be made of iron oxides or sulfide or subarsenate. Use may also be made of strontium sulfate, indeed even, in some cases of high density, of galene (lead sulfide).

Inorganic colloids, which are compounds substantially insoluble under the conditions of use of the fluid according to the invention are agents which modify the rheology of the medium and which make it possible to keep the cuttings in suspension in the latter. Attapulgite, barite or bentonite, alone or as a mixture, are the most commonly used examples thereof. It should be noted that, if use is made of a fluid comprising an inorganic colloid, the latter will preferably be attapulgite.

The contents of weighting compounds and of inorganic colloids depend on several factors which are not solely technical. This is because, while these contents are very clearly determined according to the nature of the ground through which the well passes, the scale of the cost generated by the use of these additives is taken into account (presence or not on the spot, cost and the like).

Very often, and still with the aim of minimizing the expenses incurred, the preparation of the drilling fluid is carried out with the water present on the drilling site. Thus, it is not uncommon to have available formation water (in contrast to composition water types, that is to say to water types prepared for a specific purpose) laden with salts, such as seawater, briny water types or hard water types. In this case, the content of salts in the water employed varies according to the provenance of the latter.

However, it may happen that the water available is unladen water or water which is not significantly laden. In this case, it may be appropriate to add salts, such as chlorides, for example.

It is also possible, if necessary, to add inorganic salts in order to promote the precipitation of certain ions, if they are present, in particular divalent ions. Mention may be made, for example, of the addition of sodium carbonate, in order to precipitate calcium, or sodium bicarbonate, in order to precipitate lime, in particular during redrilling operations in cement.

Mention may also be made of the addition of gypsum or calcium chloride, in order to limit the swelling of clays, or the addition of calcium hydroxide or slate lime, in order to remove bicarbonates from muds contaminated by carbon dioxide.

Here again, the content of salts depends on the rocks through which the well passes and on the water types available on the operating site and the operations can be carried out in the presence of fluids saturated with salts.

Very clearly, the drilling fluid according to the present invention can comprise standard additives from the category of high-molecular-weight polysaccharides, such as succinoglycan, wellan or gellan, of use as viscosifying agents.

Other additives which are conventional in applications relating to the exploitation of oil fields can participate in the composition of the fluid. Thus, mention may be made of agents for the transfer of free radicals, such as lower alcohols, thioureas or hydroquinone, biocides, chelating agents, surfactants, antifoaming agents or corrosion inhibitors, for example.

### Effects

### Clay-Swelling Inhibitor

During the drilling of wells, in particular during the drilling of wells intended for the recovery of oil and/or gas, drilling is often carried out through argillaceous rocks, in particular through shales. These rocks have a tendency to swell on contact with the drilling fluids, in particular on contact with aqueous fluids. The swelling is a consequence of penetration of the fluid into the rocks. Such swelling presents several problems.

Swelling along the walls of the well creates protuberances which interfere with the movement of the drilling fluid and of the drilling tools. Moreover, swelling can result in disintegration, creating bumps along the walls. These bumps and protuberances can create points of mechanical weakness in the well. The disintegrated material is composed of fine platelets which can detrimentally affect the rheological properties of the fluid, and thus interfere with its movement, and/or block the drilling tool.

A clay-swelling inhibitor is targeted at preventing the penetration of the fluid into the rocks along the walls, and inhibiting the swelling and/or the disintegration. Well bore consolidation may be concerned.

The cleared argillaceous rocks, in particular the shales, in suspension in the fluids can present problems. These suspended rocks may swell, break up, and thus modify the rheological properties of the fluids, as explained above. A clay-swelling inhibitor is targeted at preventing the penetration into the suspended cleared rocks and/or inhibiting the disintegration.

### Accretion-Inhibiting Agent

Furthermore, the suspended rocks have a tendency to aggregate together. The term used is accretion. The aggregates formed can interfere with the movement of the fluid and tools. Furthermore, they can surround the drilling head and thus block it (bit-balling phenomenon). An accretion-inhibiting agent for cleared drilled rocks is targeted at preventing these phenomena. It should be noted that a conventional agent can form a film or be adsorbed at the surface of cleared rocks without, however, preventing their agglomeration (accretion). A poorly suited clay-swelling inhibitor can even promote this accretion. There exist requirements for agents combining the inhibition of clay swelling and the inhibition of accretion.

### Filtrate-Reducing Agent

Filtrate reduction is the avoidance of loss of fluid in the well by infiltration into the rocks. Loss of fluid is to be avoided for economic reasons (cost of the fluid), for safety reasons and for productivity reasons. This is because, if the fluid should be lacking, the drilling tools may be damaged, because of overheating, poor lubrication or mechanical blocking by poorly discharged rocks, and require temporary shutdown of the drilling operation.

Furthermore, the polymers according to the invention exhibit advantageous rheological properties (increase in the viscosity) in the presence of high concentrations of salt (brines).

The polymers can in particular be used as 2-in-1 agents, or higher value agents, combining several functions chosen from the following;
clay-swelling inhibition and/or well bore consolidation,
inhibition of accretion and/or inhibition of the blocking of drilling heads (bit-balling inhibition),
lubrication,
filtrate reduction,
rheology control.

Uses as 2-in-1 agents simplify technically and economically the formulations of the fluids. Uses as clay-swelling inhibitors and accretion-inhibiting agents are particularly advantageous.

They can be used as 2-in-1 rheology-controlling agent and clay-swelling inhibitor, thus simplifying the formulations technically and economically.

### Uses

As mentioned above, the invention also relates to the use, in a drilling fluid, as clay-swelling inhibitor and/or as filtrate-reducing agent, of a polymer comprising at least 35 mol % of units comprising a betaine group, the betaine group comprising a cationic group and an anionic group.

In the context of this use, everything which has been indicated previously as regards the polymer may be made use of and is not indicated here again, the presence of the alkoxylated or hydroxylated units, however, being optional. It should be mentioned that the polymer, in the context of this use, preferably does not comprise units other than the units comprising a betaine group and optionally the alkoxylated or hydroxylated units. Advantageously, according to one embodiment, the polymer comprises:
from 65 to 99 mol % of units comprising a betaine group,
from 55 to 1 mol % of alkoxylated units, preferably:
from 80 to 90 mol % of units comprising a betaine group,
from 10 to 20 mol % of alkoxylated units.

Advantageously, according to another embodiment, the polymer comprises:
from 80 to 100 (excluded) mol % of units comprising a betaine group,
from 20 to 0 (excluded) mol % of hydroxylated units.

In aqueous silicate-based drilling fluids, use is advantageously made of the polymer which comprises the hydroxylated units.

In aqueous silicate-free drilling fluids, use is advantageously made of the polymer which comprises the alkoxylated units.

In the context of the use according to the invention, the drilling fluid is preferably a fluid for the drilling of a well intended for the recovery of oil and/or gas. The polymer content of the drilling fluid is advantageously between 0.1% and 10%, preferably between 0.1% and 5% and more preferably still between 1% and 3%.

In the context of the use according to the invention, the polymer is a clay-swelling inhibitor. It can thus be a well bore consolidation agent. It can thus be, also or alternatively, an accretion-inhibiting agent for cleared drilled rocks.

In the context of the use, the polymer can be, also or alternatively, a filtrate-reducing agent.

Other details or advantages of the invention will become more clearly apparent in the light of the examples below, without a limiting nature.

### EXAMPLES

### Example 1

### Polymer Comprising SPE Units and Poly-Alkoxylated Units (03VTA003, “SPE/PEG 70/30”)

A copolymer comprising 70% by number of units deriving from SPE and 30% by number of units deriving from Bisomer S10W, with a number-average molar mass Mn=15 000 g/mol and a weight-average molar mass Mw=26 000 g/mol (relative value measured by aqueous GPC with standardizing of the samples of poly(ethylene oxide)), is prepared by radical polymerization in a water/ethanol mixture in the following way: 5.60 g of SPE (i.e., 0.020 mol) sold by Raschig, 9.45 g of Bisomer S10W (i.e., 0.009 mol) sold by Laporte, 398 g of water and 261.90 g of ethanol are charged, at ambient temperature, to a jacketed 1.5 1 multi-necked SVL reactor equipped with a Teflon anchor stirrer and connected to a thermostat. This mixture is subsequently heated to 78° C. When this temperature is reached (time recorded as t⁰), the following are introduced:
all at once (at t⁰): 0.8250 g of ammonium persulfate (i.e., 0.004 mol) dissolved in 20 g of water,
continuously over 2 h 30 min (from t⁰ to t⁰+2 h 30 min) using a syringe driver: 2.4750 g of ammonium persulfate dissolved in 60 g of water,
continuously over 2 h (from t⁰ to t⁰+2 h) using a syringe driver: a solution containing 50.85 g of SPE (i.e., 0.182 mol), 84.15 g of Bisomer S10W (i.e., 0.078 mol) and 205.80 g of water.

Once the final introduction is complete (at t⁰+2 h 30 min), the reaction medium is maintained at 70° C. for 1 h 30. Heating is then halted.

When the reactor has returned to ambient temperature, water is added and then the ethanol is evaporated on a rotary evaporator. The final product is an aqueous solution characterized by a solids content of 27.3% (calculated by weighing a known amount of solution before drying and after drying at 115° C. for 2 h), a pH of 2.0 and a Brookfield viscosity of 36 mPa·s (measured with an RV1 spindle, at 50 rpm, at ambient temperature).

The absolute average molar masses are also measured: Mw=65 000 g/mol, Mn=8000 g/mol.

### Example 2

### Polymer Comprising SPE Units and Poly-Alkoxylated Units (03VTA002, “SPE/PEG 85/15”)

A copolymer comprising 85% by number of units deriving from SPE and 15% by number of units deriving from Bisomer S10W, with a number-average molar mass Mn=15 000 g/mol and a weight-average molar mass Mw=23 000 g/mol (relative value measured by aqueous GPC with standardizing of the samples of poly(ethylene oxide)), is prepared by radical polymerization in a water/ethanol mixture in the following way: 8.90 g of SPE (i.e., 0.032 mol) sold by Raschig, 6.09 g of Bisomer S10W (i.e., 0.006 mol) sold by Laporte, 403.75 g of water and 261.90 g of ethanol are charged, at ambient temperature, to a jacketed 1.5 1 multi-necked SVL reactor equipped with a Teflon anchor stirrer and connected to a thermostat. This mixture is subsequently heated to 78° C. When this temperature is reached (time recorded as t⁰), the following are introduced:
all at once (at t⁰): 1.0650 g of ammonium persulfate (i.e., 0.005 mol) dissolved in 20 g of water,
continuously over 2 h 30 min (from t⁰ to t⁰+2 h 30 min) using a syringe driver: 3.2100 g of ammonium persulfate dissolved in 60 g of water,
continuously over 2 h (from t⁰ to t⁰+2 h) using a syringe driver: a solution containing 80.30 g of SPE (i.e., 0.287 mol), 54.75 g of Bisomer S10W (i.e., 0.051 mol) and 169 g of water.

Once the final introduction is complete (at t⁰+2 h 30 min), the reaction medium is maintained at 78° C. for 1 h 30. Heating is then halted.

When the reactor has returned to ambient temperature, water is added and then the ethanol is evaporated on a rotary evaporator. The final product is an aqueous solution characterized by a solids content of 21.9% (calculated by weighing a known amount of solution before drying and after drying at 115° C. for 2 h), a pH of 2.0 and a Brookfield viscosity of 31 mPa·s (measured with an RV1 spindle, at 50 rpm, at ambient temperature).

The absolute average molar masses are also measured: Mw=57 500 g/mol, Mn=6500 g/mol.

### Example 3

### Polymer Comprising SPE Units and Poly-Alkoxylated Units (03VTA001, “SPE/PEG 92.5/7.5”)

A copolymer comprising 92.5% by number of units deriving from SPE and 7.5% by number of units deriving from Bisomer S10W, with a number-average molar mass Mn=14 000 g/mol and a weight-average molar mass Mw=21 000 g/mol (relative value), is prepared in the same way, at a solids content of 25.3% by weight, in a 70/30 water/ethanol mixture. The absolute average molar masses are also measured: Mw=54 000 g/mol, Mn=7500 g/mol.

### Example 4

### Homopolymer Comprising SPE Units (03VTA149, “SPE”)

A polymer comprising essentially units deriving from SPE, with a weight-average molar mass Mw=11 300 g/mol (relative value), is prepared, at a solids content of 30% by weight, by radical polymerization in water in the following way:

90 g of SPE and 403.75 g of water are charged, at ambient temperature, to a 500 ml three-necked reactor equipped with a Teflon anchor stirrer and immersed in a thermostatically controlled oil bath. The reaction medium is subsequently heated to 98° C. When this temperature is reached (time recorded as t⁰), the following are introduced:
all at once (at t⁰): 1.84 g of ammonium persulfate dissolved in 20 g of water,
all at once at t⁰+5 min: 1.84 g of ammonium persulfate dissolved in 20 g of water,
all at once at t⁰+10 min: 1.84 g of ammonium persulfate dissolved in 20 g of water,
all at once at t⁰+15 min: 1.84 g of ammonium persulfate dissolved in 20 g of water.

Once the final introduction is complete (at t⁰+15 min.), the reaction medium is maintained at 78° C. for 5 h 45 min (up to t⁰+6 h). Heating is subsequently halted.

The final product is an aqueous solution characterized by a solids content of 30% (calculated by weighing a known amount of solution before drying and after drying at 115° C. for 2 h), a pH of 1.5 and a Brookfield viscosity of 30 mPa·s (measured with an RV1 spindle, at 50 rpm, at ambient temperature).

The absolute molar masses are also measured: Mw=30 000 g/mol, Mn=4000 g/mol.

### Example 5

### Polymer Comprising SPE Units and Vicinal Diol Units (03VTA021, “SPE/GMMA 99.9/0.1”)

A copolymer comprising 99.9% by number of units deriving from SPE and 0.1% by number of GMMA units, with a number-average molar mass Mn=22 000 g/mol and with a weight-average molar mass Mw=216 000 g/mol (relative value), is prepared by radical polymerization in a water/ethanol mixture in the following way: 289.82 g of SPE (i.e., 1.073 mol) sold by Raschig, 0.18 g of GMMA (i.e., 0.001 mol) sold by Rohm and 430 g of water are charged, at ambient temperature, to a jacketed 1.5 1 multi-necked SVL reactor equipped with a Teflon anchor stirrer and connected to a thermostat. This mixture is subsequently heated to 80° C. When this temperature is reached (time recorded as t⁰), the following is introduced all at once (at t⁰): 0.2206 g of ammonium persulfate (i.e., 0.001 mol) dissolved in 20 g of water.

The reaction medium is maintained at 80° C. for 6 h. Heating is then halted.

The final product is an aqueous solution characterized by a solids content of 41.7% (calculated by weighing a known amount of solution before drying and after drying at 115° C. for 2 h). This solution is too viscous for its pH and its Brookfield viscosity to be able to be measured under the same conditions as for the polymers described in the above examples.

The absolute mean molar masses are also measured: Mw=2 000 000 g/mol, Mn=900 000 g/mol.

### Example 6

### Polymer Comprising SPE Units and Vicinal Diol Units (03VTA022, “SPE/GMMA 95/5”)

A copolymer comprising 95% by number of units deriving from SPE and 5% by number of GMMA units, with a number-average molar mass Mn=44 000 g/mol and with a weight-average molar mass Mw=230 000 g/mol (relative value), is prepared by radical polymerization in a water/ethanol mixture in the following way: 291.21 g of SPE (i.e., 1.073 mol) sold by Raschig, 8.79 g of GMMA (i.e., 0.055 mol) sold by Rohm and 430 g of water are charged, at ambient temperature, to a jacketed 1.5 1 multi-necked SVL reactor equipped with a Teflon anchor stirrer and connected to a thermostat. This mixture is subsequently heated to 80° C. When this temperature is reached (time recorded as t⁰), the following is introduced all at once (at t⁰): 0.2253 g of ammonium persulfate (i.e., 0.001 mol) dissolved in 20 g of water.

The reaction medium is maintained at 80° C. for 6 h. Heating is then halted.

The final product is an aqueous solution characterized by a solids content of 42.8% (calculated by weighing a known amount of solution before drying and after drying at 115° C. for 2 h). This solution is too viscous for its pH and its Brookfield viscosity to be able to be measured under the same conditions as for the polymers described in the above examples.

The absolute mean molar masses are also measured: Mw=3 400 000 g/mol, Mn=1 600 000 g/mol.

### Example 7

### Homopolymer Comprising SHPP Units (04CVG031, “SHPP”)

The monomer (SHPP) is synthesized and then polymerized, the final polymer being characterized by a weight-average molar mass of 200 000 g/mol (relative value).

57.16 g of CHPSNa (sodium chlorohydroxypropylsulfonate, sold by Raschig), i.e. 0.291 mol, and 943.92 g of water are charged, at ambient temperature, to a jacketed 1.5 1 multi-necked SVL reactor equipped with a Teflon anchor stirrer and connected to a thermostat. The CHPSNa dissolves in a few minutes with stirring ˜5 min). The pH of this solution is subsequently adjusted to 7.5 using dilute 10% sodium hydroxide solution. 47.72 g of dimethylaminopropylmethacrylamide, sold by Rohm, i.e. 0.280 mol, are then introduced. The mixture is heated to 80° C. and maintained at this temperature for 4 h.

The aqueous solution thus obtained (solution I) is characterized by a solids content of 24.7% (calculated by weighing a known amount of solution before drying and after drying at 115° C. for 2 h) and a pH of 8.7. The ¹H NMR analysis in D₂O shows that the tertiary amine monomer has been virtually completely converted to sulfobetaine monomer: 93% of the dimethylaminopropyl-methacrylamide is converted to SHPP monomer. 36.67 g of this solution I and 137.5 g of water are charged, at ambient temperature, to a jacketed 1.5 1 multi-necked SVL reactor equipped with a Teflon anchor stirrer and connected to a thermostat. The mixture is heated to 85° C. When this temperature is reached (time recorded at t⁰), the following are introduced:
continuously over 2 h (from to t⁰ to t⁰+2 h) using a syringe driver: 330 g of solution I,
continuously over 4 h (from t⁰ to t⁰+4 h) using a syringe driver: a solution containing 0.313 g of ammonium persulfate dissolved in 45.89 g of water.

Once the final introduction is complete (at t⁰+4h) the reaction medium is maintained at 85° C. for 4 h (from t⁰+4 h to t⁰+8 h). Heating is subsequently halted.

The final product is an aqueous solution characterized by a solids content of 18% (calculated by weighing a known amount of solution before drying and after drying at 115° C. for 2 h) and a pH of 6.3.

The absolute molar masses are also measured: Mw=880 000 g/mol, Mn=300 000 g/mol.

### Example 8

### Fluid Comprising a Polymer

An aqueous drilling mud formulation A is prepared which comprises the following ingredients:
Salt water comprising 200 g/l of NaCl,
NaOH, in order to obtain a pH of 10,
Xanthan gum, 2 ppb (23P Rhodopol, sold by Rhodia) (or 0.5% w/v),
Antifoaming agent, 0.1% by weight (Bevaloid 6092, sold by Rhodia),
Test additive (polymer according to examples 1 to 8, or other).

A silicate-based drilling mud formulation B is prepared which comprises the following ingredients:

| | |
|---|---|
| Brine | 20% |
| Antifoaming agent (Bevaloid 6092) | 0.1% |
| Thickening agent, xanthan gum | |
| (Rhodopol 23P, Rhodia) | 0.5% |
| Silicates (Silicate 60N20, Rhodia) | 5% (dry matter) |
| Test additive (polymer according to | |
| examples 1 to 8, or other) | 1% or 3% |

### KOH or NaOH, in order to adjust the pH to 12.

### Recovery Test on the Cuttings

Clay particles are used to simulate the cuttings. The clay used is Oxford clay, 2-4 mm, sold by Hanson Brick, a highly reactive and dispersive clay. The particles are sieved for a final size distribution between 2-4 mm.

30 g of sieved particles are added to 350 ml of the test formulation. The flasks are placed in a rolling oven at 65° C. for 16 hours (hot rolling). After rolling, the samples are cooled and the particles are recovered on a sieve (2 mm) and washed with a brine solution. The excess formulation is carefully removed using adsorbent paper. The particles are weighed. The particles are dried in an oven at 50° C. until a stable weight is achieved, in order to have a precise indication of the water content inside the particles. The particles are again weighed and the percentage of moisture restoration is calculated. High levels of restoration and low moisture contents indicate an inhibiting effect on clay swelling.

### Extrusion test

Hot rolling is carried out in the presence of the clay particles, at 65° C. for 16 hours, as indicated above. Afterwards, the particles are recovered on a sieve, washed with brine and extruded in a CT 15 compressometer device from Adamel Lhomargy at a rate of 40 mm/min. The pressure necessary to extrude the particles is measured. It depends on the degree of hydration of the particles. The harder the particles, the higher the pressure, the better the protection with regard to penetration of water and thus the better the inhibiting effect on clay swelling.

### Results

Eight different additives are tested at different concentrations in the fluid in accordance with the example (concentration by weight on a dry basis). The results are given in table I.

TABLE I

| | | | | Moisture | Moisture | |
|---|---|---|---|---|---|---|
| | Additive | | | content | restoration | Pressure |
| Example | tested | Summary | Formulation | (%) | (%) | (bar) |
| 9 | Example | SPE, 1% | A | 29 | 99 | 26 |
| | 4, 1% | | | | | |
| 10 | Example | SPE, 2% | A | 29.5 | 98 | 24 |
| | 4, 2% | | | | | |
| 11 | Example | SPE, 3% | A | 33 | 94 | 35 |
| | 4, 3% | | | | | |
| 12 | Example | SPE/PEG | A | 28.7 | 101.4 | 36 |
| | 2, 1% | 85/15 | | | | |
| 13 | Example | SPE/PEG | A | 37.6 | 108 | 27 |
| | 3, 1% | 92.5/7.5 | | | | |
| 14 | PHPA*, | | A | 28 | 102 | 26 |
| (comparative) | 0.2% | | | | | |
| 15 | KCl, 1% | | A | | | 9 |
| (comparative) | | | | | | |
| 16 | Example | SPE/PEG | A | | | 55 |
| | 1, 1% | 70/30 | | | | |
| 17 | Example | SPE/GMMA | A | | | 29 |
| | 5, 1% | 99.9/0.1 | | | | |
| 18 | Example | SPE/GMMA | | | | 29 |
| | 6, 1% | 95/5 | | | | |
| 19 | Example | SHPP | | | | 33 |
| | 7, 1% | | | | | |

*Polivis PW, sold by Ava.

### Anti-Accretion Test

175 ml of the formulation/mud and 15 g of the clay particles are placed in 250 ml polypropylene flasks. A preweighed steel bar is added thereto and the flasks are placed horizontally on moving rollers at ambient temperature for 1 minute. The bar is subsequently removed from the flask and photographed. It is subsequently placed in an oven at 105° C. to constant weight.

The following is calculated: % accretion=weight (g) of dry particles stuck to the bar/weight (g) of particles used for the test*. *The moisture content is taken into account in order to calculate the starting weight of the clays.

The lower the value, the better it is.

The results are presented in table II below.

TABLE II

| | Additive | | | Accretion |
|---|---|---|---|---|
| Example | tested | Summary | Formulation | (%) |
| 20 | / | | B | 58 |
| 21 | Example 1, | SPE/PEG | B | 58 |
| | 1% | 70/30 | | |
| 22 | Example 5, | SPE/GMMA | B | 25 |
| | 1% | 99.9/0.1 | | |
| 23 | Example 6, | SPE/GMMA | B | 40 |
| | 1% | 95/5 | | |

1-41. (canceled)

42. A zwitterionic polymer comprising units having a betaine group, comprising:
at least 35 mol % of units having a betaine group, the betaine group having a cationic group and an anionic group, and
additional units selected from the group consisting of:
alkoxylated units of following formula:
—CH₂—CHR⁶[—X²—(CH₂—CH₂—O)ₙ—R⁷]—
in which:
R⁶ is a hydrogen atom or a methyl group,
X² is a group of formula —CO—O—, —CO—NH— or —C₆H₄—CH₂—,
n is an integer or mean number of greater than or equal to 1,
R⁷ is a hydrogen atom, an alkyl group or a tristyrylphenyl group, and/or
hydroxylated units of following formula:
—CH₂—CHR⁶[—X²—R⁸]—
in which:
R⁶ is a hydrogen atom or a methyl group,
X² is a group of formula —CO—O—, —CO—NH— or —C₆H₄—CH₂—,
R⁸ is a hydrocarbon group of at least two carbon atoms having at least two —OH groups, preferably on two consecutive carbon atoms.

43. The polymer as claimed in claim 42, wherein the anionic group is a carbonate, sulfonate, phosphate, phosphonate, phosphinate or ethenolate group and wherein the cationic group is an ammonium, pyridinium, imidazolinium, phosphonium or sulfonium group.

44. The polymer as claimed in claim 42, wherein the betaine groups are pendent groups of the polymer.

45. The polymer as claimed in claim 42, wherein the units having a betaine group and optionally the alkoxylated and/or hydroxylated units form a polyalkylene hydrocarbon chain optionally interrupted by one or more nitrogen or sulfur atoms.

46. The polymer as claimed in claim 42, wherein the units having a betaine group derive from at least one betaine monomer selected from the group consisting of the following monomers:
alkyl sulfonates of dialkylammonium alkyl acrylates, alkyl sulfonates of dialkyl-ammonium alkyl methacrylates, alkyl phosphonates of dialkylammonium alkyl acrylates, alkyl phosphonates of dialkylammonium alkyl methacrylates, alkyl sulfonates of dialkylammonium alkyl acrylamido, alkyl sulfonates of dialkyl-ammonium alkyl methacrylamido, alkyl phosphonates of dialkylammonium alkyl acrylamido, alkyl phosphonates of dialkylammonium alkyl methacrylamido, heterocyclic betaine monomers,
alkyl sulfonates of dialkylammonium alkyl allylics, alkyl phosphonates of dialkyl-ammonium alkyl allylics,alkyl sulfonates of dialkylammonium alkyl styrenes, alkyl s phosphonates of dialkylammonium alkyl styrenes, betaines resulting from ethylenically unsaturated anhydrides and dienes, sulfobetaines derived from piperazine, sulfobetaines derived from 2-vinylpyridine, sulfobetaines derived from 4-vinylpyridine, phosphobetaines of formulae 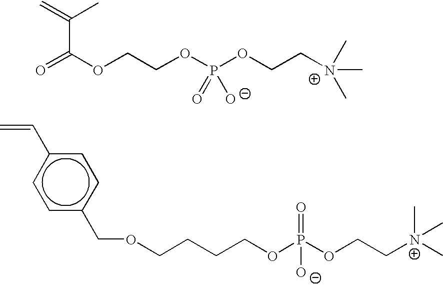
and betaines resulting from cyclic acetals.

47. The polymer as claimed in claim 46, wherein the units having a betaine group derive from at least one betaine monomer selected from the group consisting of the following monomers:
sulfopropyldimethylammonioethyl methacrylate,
sulfoethyldimethylammonioethyl methacrylate,
sulfobutyldimethylammonioethyl methacrylate,
sulfohydroxypropyldimethylammonioethyl methacrylate,
sulfopropyldimethylammoniopropylacrylamide,
sulfopropyldimethylammoniopropylmethacrylamide,
sulfopropyldiethylammonioethyl methacrylate,
sulfohydroxypropyldimethylammoniopropylmethacrylamide,
sulfohydroxypropyldiethylammonioethyl methacrylate,
2-vinyl-1-(3-sulfopropyl)pyridinium betaine,
4-vinyl-1-(3-sulfopropyl)pyridinium betaine,
1-vinyl-3-(3-sulfopropyl)imidazolium betaine,
sulfopropylmethyldiallylammonium betaine, and
((dicyanoethanolate)ethoxy)dimethylammoniumpropylmethacrylamide.

48. The polymer as claimed in claim 42, wherein the units having a betaine group exhibit one of the following formulae:

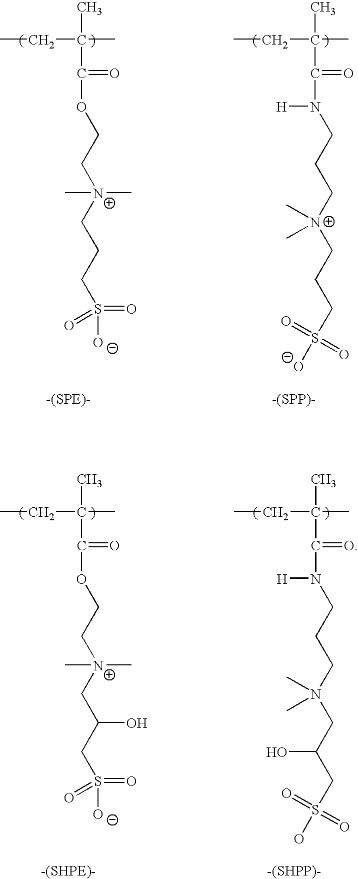

49. The polymer as claimed in claim 42, wherein the alkoxylated units are units deriving from a monomer of following formula:
CH₂═CHCH₃COO—(CH₂—CH₂—O)ₙ—R⁷
in which:
n is an integer or mean number of greater than or equal to 1,
R⁷ is an alkyl group having 1 to 30 carbon atoms or a tristyrylphenyl group.

50. The polymer as claimed in claim 49, wherein:
n is greater than or equal to 10, preferably greater than or equal to 15, and
R⁷ is a methyl group.

51. The polymer as claimed in claim 49, wherein:
n is greater than or equal to 10, and
R⁷ is an alkyl group having from 12 to 30 carbon atoms, optionally from 18 to 25.

52. The polymer as claimed in claim 49, wherein:
n is greater than or equal to 10, and
R⁷ is a tristyrylphenyl group.

53. The polymer as claimed in claim 42, wherein:
n is greater than or equal to 10, and
R⁷ is a hydrogen atom.

54. The polymer as claimed in claim 42, wherein the hydroxylated units are chosen from the units of following formulae:

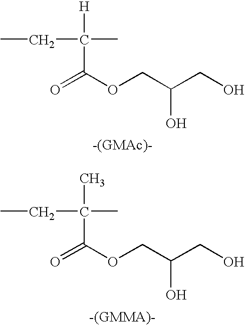

55. The polymer as claimed in claim 42, not comprising other units, the polymer optionally exhibiting solely the units having a betaine group and the alkoxylated units or solely the units having a betaine group and the hydroxylated units.

56. The polymer as claimed in claim 42, having a weight-average molecular mass of between 5000 g/mol and 400 000 g/mol, in relative value, measured by GPC calibrated with poly(ethylene oxide) standards.

57. The polymer as claimed in claim 42, comprising:
from 65 to 99 mol % of units having a betaine group, and
from 55 to 1 mol % of alkoxylated units,
optionally:
from 70 to 90 mol %, of units having a betaine group, and
from 10 to 30 mol %, of alkoxylated units.

58. The polymer as claimed in claim 42, comprising:
from 80 to 100 (excluded) mol % of units having a betaine group, and
from 20 to 0 (excluded) mol % of hydroxylated units.

59. A drilling fluid comprising the polymer as claimed in claim 42.

60. The drilling fluid as claimed in claim 59, wherein the polymer content is between 0.1% and 10%, optionally between 1% and 3%.

61. A clay-swelling inhibitor and/or as accretion-inhibiting agent and/or as fluid-rheology-controlling agent and/or as filtrate-reducing agent and/or as lubricating agent for a drilling fluid, comprising a polymer as defined in claim 42.
